(19) United States
(12) Patent Application Publication
(10) Pub. No.: US 2026/0267160 A1
(43) Pub. Date: Sep. 10, 2026

(54) Foam-Framed Modular Eyeglasses

(71) Applicant: Stan Austin Soldner, Los Angeles, CA (US)

(72) Inventor: Stan Austin Soldner, Los Angeles, CA (US)

(21) Appl. No.: 19/562,435

(22) Filed: Mar. 10, 2026

Related U.S. Application Data
(60) Provisional application No. 63/769,649, filed on Mar. 10, 2025.

(51) Int. Cl. G02C 5/00

(52) U.S. Cl. CPC G02C 5/008; G02C 2200/08

(57) ABSTRACT

A modular floating pair of eyeglasses is disclosed, wherein the frame comprises a single piece of flexible foam material where interchangeable lenses can snap in. In an embodiment, the frame may also comprise decoration mounting holes where decorative elements can snap in.

### CROSS-REFERENCE TO RELATED APPLICATIONS

The present application takes priority from Provisional App. No. 63/769,649, filed Mar. 10, 2025, which is incorporated herein by reference.

### BACKGROUND

### Field of the Invention

The present invention relates generally to eyewear and more specifically to eyewear designed for active people who engage in boating or watersports.

People who enjoy boating or watersports need eyeglasses or sunglass designs that float and that are tough and resistant to breakage. People who enjoy sports that involve occasional impact need eyeglasses or sunglasses that are impact-resistant and will not break easily. A need exists for such a design.

Furthermore, sunglasses are not always comfortable for many people and can press uncomfortably on the temples or the nose. Since everyone's face is different, people with non-standard shaped faces may have trouble finding sunglasses that fit. A need exists for sunglasses that are comfortable and do not create pressure points.

Finally, sunglasses typically come with only one set of lenses that is impossible to replace by a casual user. If the day turns out to be sunnier than anticipated, a user might want darker lenses; a user may want orange lenses for use in snow; a user might want yellow lenses for greater clarity while driving at night. A need exists for sunglasses that have easily interchangeable lenses.

### SUMMARY OF THE INVENTION

An object of the present invention is to provide a pair of eyeglasses that float in water.

Another object of the present invention is to provide a pair of eyeglasses with easily interchangeable lenses.

Another object of the present invention is to provide a pair of eyeglasses that are comfortable to wear.

Another object of the present invention is to provide a pair of eyeglasses that are resistant to breaking.

In an embodiment, the present invention comprises a pair of eyeglasses comprising a frame and two lenses, wherein the frame is made of a single piece of foam material with a density lower than the density of water. The foam material has a Shore hardness between 50 and 60. The lenses are removably inserted into the frame. The lenses can be sunglass lenses.

In an embodiment, the pair of eyeglasses can also comprise decorative elements. In that embodiment, at least one arm of the eyeglasses comprises at least one decoration mounting hole, and an ornament can snap into the decoration mounting hole.

In an embodiment, the pair of eyeglasses can comprise additional lenses that can be removably inserted into the frame.

In an embodiment, one of the arms of the pair of eyeglasses can be attached to the other so that the eyeglasses can be worn as a bracelet.

### LIST OF FIGURES

FIG. 1 shows a view of an embodiment of the eyeglasses of the present invention.

FIG. 2 shows a view of an embodiment of the present invention worn as a bracelet.

FIG. 3 shows a close-up view of the lens insertion and removal features of an embodiment of the present invention.

FIG. 4 shows a close-up view of an ornament and decoration mounting hole of an embodiment of the present invention.

### DETAILED DESCRIPTION OF THE PREFERRED EMBODIMENT

It will be understood that the below description is for illustrative purposes only and is not intended to be limiting. The present invention is only limited by the appended claims.

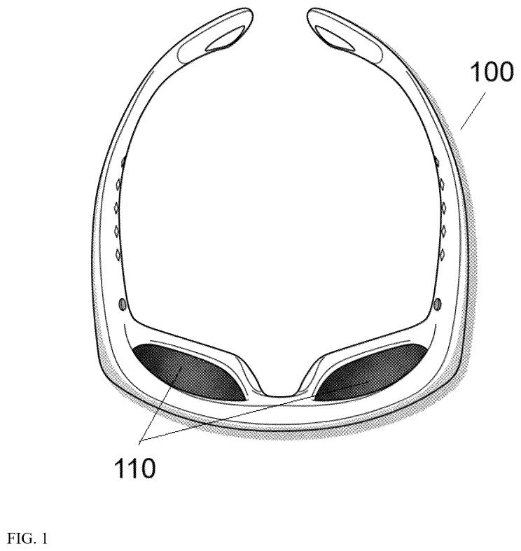

FIG. 1 shows an embodiment of the pair of eyeglasses of the present invention. Frame 100 is a single piece of closed-cell foam material, preferably EVA (ethylene-vinyl acetate) foam, with a Shore A hardness between about 20 and about 70, and preferably between about 50 and about 60, as measured per ASTM D2240. Lenses 110 snap into the frame 100; since the material is somewhat elastic and flexible, it is easy to snap the lenses into it, and the lenses stay secure. The lenses 110 can be sunglass lenses, plain glass lenses, prescription lenses, colored lenses, or any other lenses that can be used in eyewear.

In alternative embodiments, the frame 100 may be made of other closed-cell foam materials including but not limited to polyurethane foam, polyethylene foam, neoprene foam, or silicone foam, provided that the foam material has a density less than the density of water and a Shore A hardness between about 20 and about 70. As used herein, the term “about” when used in connection with a numerical value means within plus or minus ten percent (±10%) of the stated value. The density of the foam material is preferably between about 0.05 g/cm³ and about 0.90 g/cm³, and more preferably between about 0.10 g/cm³ and about 0.30 g/cm³.

Since the foam material is flexible, it does not require the frame to have hinges; the entire frame can be one single piece of material. This improves the durability of the eyeglasses and reduces the cost of manufacture. For example, a user could accidentally sit on the eyeglasses and not break the frame, since it is one piece of highly flexible material.

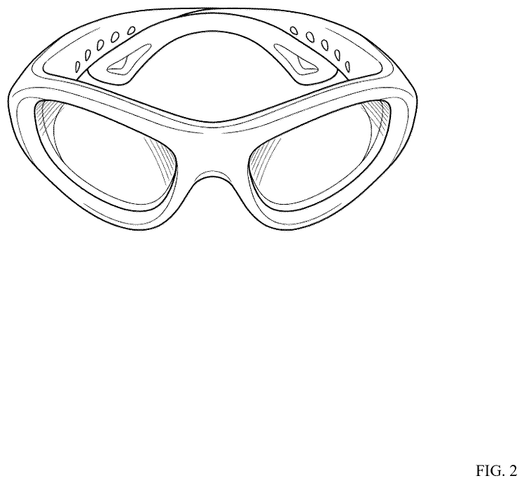

The flexibility of the material can also mean that the eyeglasses can be flexed into other shapes when not in use. For example, in an embodiment, the eyeglasses can be worn as a bracelet when not needed, simply by attaching one of the arms to the other as shown in FIG. 2.

In an embodiment, the foam material can be thermoformed at low temperatures, for example at temperatures between 60° C. and about 90° C. This means that an individual user may use a commonly available heat source such as a hairdryer or boiling water to reshape the eyeglass frame to fit their face better. The eyeglasses will then retain their shape when cooled down. Foam materials that are thermoformable are therefore preferable for practicing the present invention, and include EVA foam and polyurethane foam.

The foam material has a density that is less than the density of water. This means that the eyeglasses will float in water. Since people often wear sunglasses during watersports or boating, this is a highly useful feature of this invention. The density of the foam material is preferably between about 0.05 g/cm³ and about 0.90 g/cm³, and more preferably between about 0.10 g/cm³ and about 0.30 g/cm³. Having a lower density will ensure that even though the lens material may be heavier than water, the eyeglasses as a whole will still remain buoyant in water.

The foam material is softer than the hard plastic used for most sunglass or eyeglass frames. The Shore A hardness of the material is between 20 and 70; in the preferred embodiment, the Shore A hardness of the material is between 50 and 60. (In comparison, an acetate eyeglass frame would have a Rockwell hardness of 34-125.) This means that it will be more comfortable and that it will not produce as many pressure points as hard plastic or metal frames.

In an embodiment, the eyeglasses of the present invention can have interchangeable lenses that a user can change easily. For example, a user can swap out darker sunglass lenses for lighter ones once the sun is not as strong, or put in yellow driving-safety lenses instead of sunglass lenses when driving at night. This saves the user from having to acquire multiple pairs of glasses.

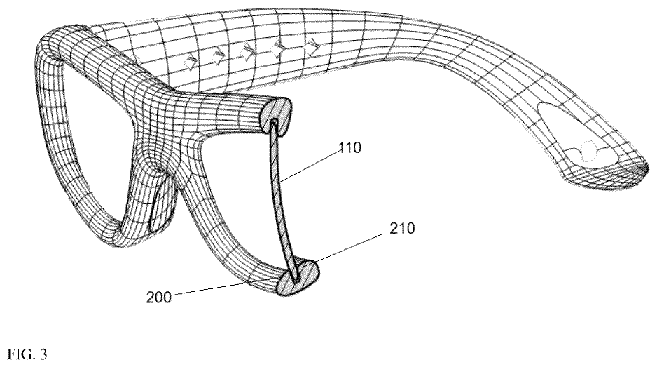

In an embodiment shown in FIG. 3, the front lip 200 and back lip 210 define a lens-receiving channel having a width that is slightly less than the thickness of the lens 110 when the frame is in an undeformed state. To insert or remove the lens 110, a user applies a manual force to deform the front lip 200 and/or back lip 210 outward, temporarily widening the channel to permit the lens to pass through. Upon release of the manual force, the resilient foam material returns to its undeformed state and the front lip 200 and back lip 210 exert a retention force on opposing faces of the lens 110, frictionally securing the lens in place. In an embodiment, the front lip 200 extends inwardly by between about 1 mm and about 4 mm, and the back lip 210 extends inwardly by between about 1 mm and about 4 mm.

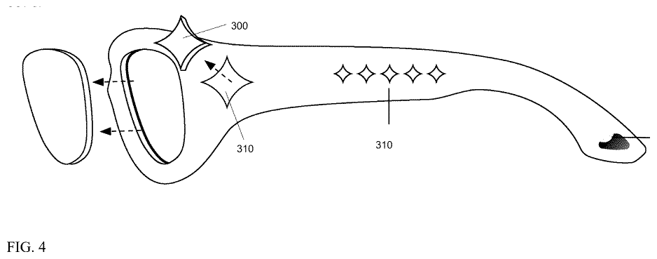

In an embodiment, shown in FIG. 4, ornaments can be removably attached to the eyeglasses. It will be understood that these are not required to practice the present invention. Since the foam material is elastic, an ornament 300 can be snapped into a decoration mounting hole 310. As shown, multiple decoration mounting holes 310 can be placed on the arms of the eyeglasses. In an embodiment, the decoration mounting holes 310 are diamond-shaped so that the eyeglasses look good even when no ornaments are inserted, and to prevent the ornaments from rotating once they are inserted. The ornaments may be made of metal and may be gold-toned to improve the appearance of the eyeglasses. In an embodiment, imitation gemstones may also be included.

Exemplary embodiments are described above. It will be understood to a person of reasonable skill in the art that the present invention includes other embodiments, comprising other elements that are reasonable equivalents to the elements described above.

1. A pair of eyeglasses, comprising:
a frame comprising two arms and a facepiece, wherein the two arms and the facepiece are formed from a single piece of resilient foam material, wherein the resilient foam material has a density less than the density of water, and wherein the resilient foam material is configured to be resiliently deformable;
a first set of lenses comprising two lenses, each removably inserted into the frame, wherein the resilient foam material exerts a retention force on each of the first set of lenses when inserted.

2. The pair of eyeglasses of claim 1, wherein the resilient foam material is closed-cell foam.

3. The pair of eyeglasses of claim 2, wherein the closed-cell foam is EVA (ethylene-vinyl acetate) foam.

4. The pair of eyeglasses of claim 1, wherein the resilient foam material has a Shore A hardness between about 20 and about 70.

5. The pair of eyeglasses of claim 4, wherein the resilient foam material has a Shore A hardness between about 50 and about 60.

6. The pair of eyeglasses of claim 1, wherein the resilient foam material has a density between about 0.05 g/cm³ and about 0.90 g/cm³.

7. The pair of eyeglasses of claim 1, wherein the resilient foam material has a density between about 0.1 g/cm³ and about 0.3 g/cm³.

8. The pair of eyeglasses of claim 1, wherein the resilient foam material is thermoformable at temperatures between 60° C. and 90° C.

9. The pair of eyeglasses of claim 1, wherein the frame defines a lens-receiving channel for each of the first lens and the second lens, the lens-receiving channel comprising a front lip and a back lip that extend perpendicular to a surface of the lens-receiving channel to engage opposing faces of the respective lens, and wherein the front lip and the back lip are resiliently deformable to permit insertion and removal of the respective lens.

10. The pair of eyeglasses of claim 9, wherein the front lip extends from the surface of the lens-receiving channel by between 1 mm and 4 mm and the back lip extends inwardly by between 1 mm and 4 mm.

11. The pair of eyeglasses of claim 1, wherein each of the two arms comprise a fastener such that the two arms can be fastened to each other in such a way that the pair of eyeglasses forms a bracelet configuration that can be worn around a user's wrist.

12. An eyewear kit, comprising the eyeglasses of claim 1, and further comprising:
a second set of lenses removably insertable into the frame, wherein the second set of lenses has different optical characteristics from the first set of lenses.

13. The eyewear kit of claim 12, wherein the first set of lenses comprises sunglass lenses and the second set of lenses comprises clear lenses or night-driving lenses.

14. The eyewear kit of claim 12, wherein the frame comprises at least one decoration mounting hole on at least one arm, and further comprising at least one ornament configured to snap into the decoration mounting hole.
